(19) United States
(12) Patent Application Publication
(10) Pub. No.: US 2004/0117193 A1
(43) Pub. Date: Jun. 17, 2004

(54) Audio decoding reproduction apparatus

(75) Inventor: Takahiro Kawai, Tokyo (JP)

Correspondence Address: BURNS, DOANE, SWECKER & MATHIS, L.L.P., P.O. Box 1404, Alexandria, VA, 22313-1404, US

(73) Assignee: RENESAS TECHNOLOGY CORPORATION

(21) Appl. No.: 10/454,604

(22) Filed: Jun. 5, 2003

(30) Foreign Application Priority Data
Dec. 12, 2002 (JP) 2002-361211

(51) Int. Cl. G10L 19/00; G10L 21/00

(52) U.S. Cl. 704/500

(57) ABSTRACT

An audio decoding reproduction apparatus includes an input data analyzer, a decoding channel controller and a decoding processor. The input data analyzer analyzes an input data stream to decide the number and types of the source channels of the input data stream. The decoding processor generates decoded data of at least one channel by decoding data in the input data stream. In response to the number and types of the source channels the input data analyzer decides, the decoding channel controller adjusts the number and types of the channels of the decoded data the decoding processor decodes. The audio decoding reproduction apparatus can make effective use of its processing ability without generating the unnecessary decoded data.

### BACKGROUND OF THE INVENTION

1. Field of the Invention

The present invention relates to an audio decoding reproduction apparatus.

2. Description of Related Art

As multi-channel audio reproduction technology such as the Dolby digital system (the trade mark of Dolby Laboratories Inc.) expands, audio decoding reproduction apparatuses have been developed for decoding encoded audio data recorded in a plurality of source channels (see, Relevant Reference 1 which is incorporated here by reference, for example).

Relevant Reference 1: Japanese patent application laid-open No. 10-340099/1998.

It is a common practice for such conventional audio decoding reproduction apparatuses to output decoded data of a specified number of channels regardless of the number of channels of the source audio data. For example, even if the source audio data have only two channels of L (left) and R (right), the audio decoding reproduction apparatus outputs 6-channel decoded data of L (left), C (center), R (right), SW (sub-woofer for low-frequency sounds), Ls (left surround) and Rs (right surround). In this case, the outputs of the 4-channels C, SW, Ls and Rs, which do not contribute to actual generation of the sounds, are always zero.

It is a waste of processing ability to generate such decoded data that do not contribute to the generation of the practical sounds. In addition, such useless decoded data undergo internal processing such as transfer within the audio decoding reproduction apparatus, which is also a waste of the processing ability.

### SUMMARY OF THE INVENTION

The present invention is implemented to solve the foregoing problem. It is therefore an object of the present invention to provide an audio decoding reproduction apparatus capable of eliminating the need for generating the unnecessary decoded data, thereby making effective use of the processing ability.

According to one aspect of the present invention, there is provided an audio decoding reproduction apparatus in which a decoding channel controller controls the number and types of channels of the data to be decoded by a decoding processor, in response to the number and types of the source channels of the input data stream decided by the input data analyzer. Accordingly, when the number of the source channels of the input data stream is less than that of the output channels, it does not generate nor output the decoded data of the unnecessary channels. As a result, it can reduce the amounts of the generation and transfer of the data that do not contribute to generating the actual sounds whose outputs always zero, thereby enabling the effective use of the processing ability. Consequently, it can speed up the processing depending on the operating environment.

### BRIEF DESCRIPTION OF THE DRAWINGS

FIG. 1 is a block diagram showing a configuration of an embodiment 1 of the audio decoding reproduction apparatus in accordance with the present invention;

FIG. 2 is a block diagram showing a detailed configuration of the audio decoder of the audio decoding reproduction apparatus as shown in FIG. 1;

FIG. 3 is a block diagram showing a configuration of an embodiment 2 of the audio decoding reproduction apparatus in accordance with the present invention;

FIG. 4 is a block diagram showing a configuration of an embodiment 3 of the audio decoding reproduction apparatus in accordance with the present invention; and

FIG. 5 is a block diagram showing a configuration of an embodiment 4 of the audio decoding reproduction apparatus in accordance with the present invention.

### DETAILED DESCRIPTION OF THE PREFERRED EMBODIMENTS

The invention will now be described with reference to the accompanying drawings.

### Embodiment 1

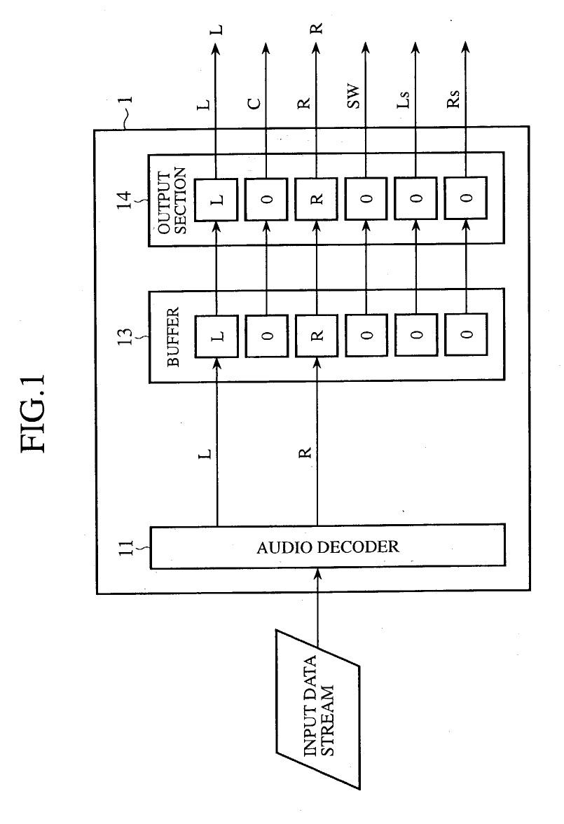

FIG. 1 is a block diagram showing a configuration of an embodiment 1 of the audio decoding reproduction apparatus in accordance with the present invention. As shown in FIG. 1, the audio decoding reproduction apparatus 1 includes an audio decoder 11, a buffer 13, and an output section 14. The audio decoder 11 decodes an encoded input data stream recorded in a plurality of source channels, and generates PCM (pulse code modulation) data. The PCM data decoded by the audio decoder 11 are temporarily stored in the FIFO (first-in, first-out) type buffer 13. The data blocks stored in the buffer 13 are sequentially read by the output section 14, and supplied to an external apparatus (such as an amplifier) not shown.

The audio decoding reproduction apparatus 1 is capable of producing 6-channel (or 5.1-channel because the SW is considered to be 0.1 channel) decoded data of L (left), C (center), R (right), SW (sub-woofer for low frequency sounds), Ls (left surround) and Rs (right surround) at the maximum.

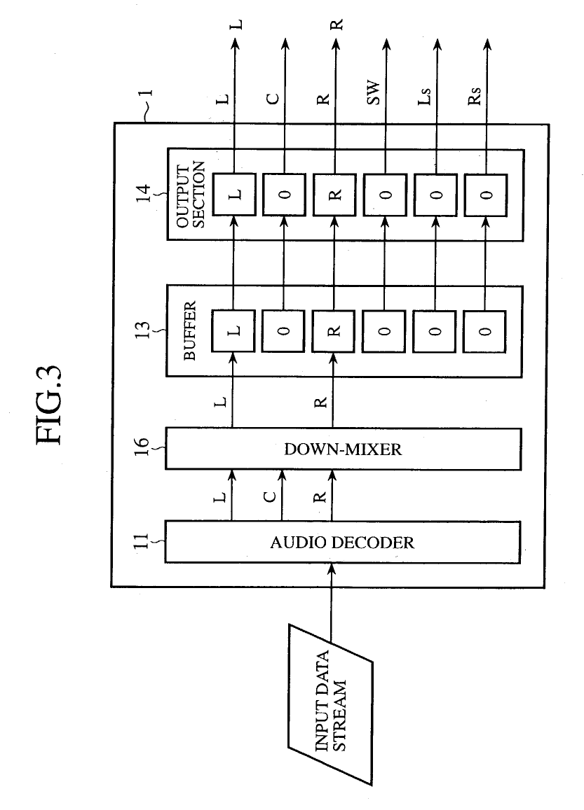

The buffer 13 includes storage areas for the individual channels. Although FIG. 1 (and FIGS. 3-5 described below) includes only one storage area for each channel, a plurality of storage areas are usually prepared for each channel.

The input data stream can be a data stream the audio decoding reproduction apparatus 1 reads from a recording medium such as a DVD (digital versatile disk), or a data stream the audio decoding reproduction apparatus 1 obtains through communication. The number of the source channels of the input data stream is not limited to six. It can be any number equal to or greater than one.

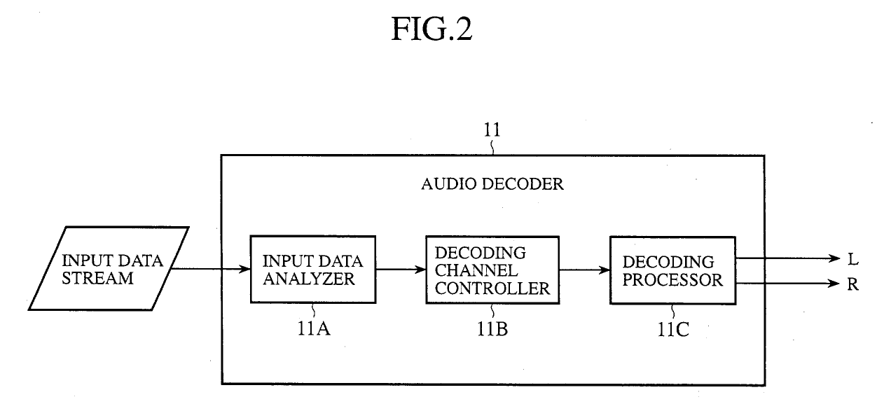

FIG. 2 is a block diagram showing a detailed configuration of the audio decoder of the audio decoding reproduction apparatus as shown in FIG. 1. The audio decoder 11 comprises an input data analyzer 11A, a decoding channel controller 11B, and a decoding processor 11C. The input data analyzer 11A analyzes the input data stream to decide the number and types of the source channels of the input data stream. The decoding processor 11C decodes the data in the input data stream.

In accordance with the number and types of the source channels decided by the input data analyzer 11A, the decoding channel controller 11B adjusts the number and types of channels of the PCM data to be decoded by the decoding processor 11C. More specifically, the decoding processor 11C generates the decoded PCM data only from the source channel data contained in the input data stream. Thus, the number and types of the channels of the PCM data to be decoded by the decoding processor 11C are matched to those of the input data stream. For example, when the source channels of the input data stream are L and R, the decoding processor 11C generates the decoded PCM data of the channels L and R under the control of the decoding channel controller 11B as shown in FIG. 2. On the other hand, when the source channels of the input data stream are L, C, R, Lfe (low frequency effect only for low frequency sounds), Ls and Rs, the decoding processor 11C generates the decoded PCM data of the channels L, C, R, SW (corresponding to Lfe), Ls and Rs under the control of the decoding channel controller 11B.

The decoded PCM data the audio decoder 11 generates are temporarily stored in the storage areas for the individual channels in the buffer 13 to be sequentially read by the output section 14.

As described above, according to the present embodiment 1, the decoding channel controller 11B adjusts the number and types of the channels of the PCM data to be decoded by the decoding processor 11C, in accordance with the number and types of the source channels of the input data stream decided by the input data analyzer 11A. Accordingly, when the number of the source channels of the input data stream is less than the maximum number of available output channels, the present embodiment 1 does not generate nor output the PCM data of unnecessary channels. Consequently, the outputs of the unnecessary channels are made always zero, and hence the present embodiment 1 can reduce the volumes of generation and transfer of the data that do not serve for generating the actual sounds, thereby enabling effective use of the processing ability. Thus, it can implement high-speed processing depending on the operating environment.

### Embodiment 2

FIG. 3 is a block diagram showing a configuration of an embodiment 2 of the audio decoding reproduction apparatus 1 in accordance with the present invention. In FIG. 3, the same reference numerals and symbols as those of FIG. 1 designate the same or like portions, and their detailed description will be omitted.

The audio decoding reproduction apparatus 1 of the present embodiment 2 includes a down-mixer 16, which is supplied with the decoded PCM data from the audio decoder 11. According to the usage mode of a user, that is, the number and types of speakers to be used for listening, the down-mixer 16 converts the decoded PCM data supplied from the audio decoder 11 into output data with the number of output channels of the output section 14. The output data of the down-mixer 16 are temporarily stored in the storage areas for the individual channels in the buffer 13, and are sequentially read by the output section 14 to be supplied to the external apparatus (an amplifier, for example) not shown.

The audio decoder 11 is the same as the audio decoder 11 of the foregoing embodiment 1. The number and types of the channels of the PCM data to be decoded by the decoding processor 11C (see, FIG. 2) are matched to the number and types of the source channels of the input data stream. For example, when the source channels of the input data stream are L, C and R, the decoding processor 11C generates the decoded PCM data of the channels L, C and R under the control of the decoding channel controller 11B.

Typically, the number and types of the output channels of the down-mixer 16 are variable in accordance with the setting of a user. For example, the down-mixer 16 can distribute the C channel input to the L and R channel outputs. Thus, the decoded PCM data of the channels L, C and R are output to the L and R channels by the down-mixing.

Although not shown in FIG. 3, the same distribution is achievable for the remaining channels. For example, the down-mixer 16 can distribute the SW channel input to the L and R channel outputs, or the Ls channel input to the L channel output.

As described above, the present embodiment 2 can carry out the down-mixing in addition to the advantages of the foregoing embodiment 1.

### Embodiment 3

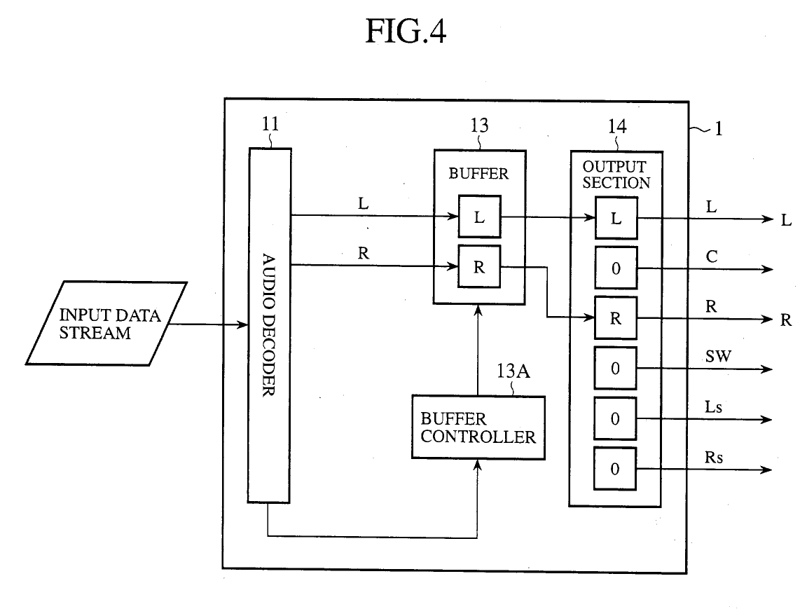

FIG. 4 is a block diagram showing a configuration of an embodiment 3 of the audio decoding reproduction apparatus 1 in accordance with the present invention. In FIG. 4, the same reference numerals and symbols as those of FIG. 1 designate the same or like portions, and their detailed description will be omitted.

The audio decoder 11 is the same as the audio decoder 11 of the foregoing embodiment 1 in that according to the number and types of the source channels the input data analyzer 11A (refer to FIG. 2) decides, the decoding channel controller 11B adjusts the number and types of the channels of the PCM data to be decoded by the decoding processor 11C. Thus, the number and types of the channels of the PCM data to be decoded by the decoding processor 11C (refer to FIG. 2) are matched to the number and types of the source channels of the input data stream.

In the present embodiment 3, the audio decoding reproduction apparatus 1 includes a buffer controller 13A. According to the number and types of the source channels the input data analyzer 11A decides, the buffer controller 13A controls the storage areas used by the buffer 13 for temporarily storing the decoded PCM data (output data). Although the buffer 13 has the storage areas for the maximum number of output channels, the buffer controller 13A usably reserves the storage areas only for the number and types of the channels corresponding to those of the source channels (that is, those of the channels of the PCM data the decoding processor 11C of the audio decoder 11 outputs).

As described above, according to the present embodiment 3, the buffer controller 13A controls the storage areas the buffer 13 uses for temporarily storing the output data in response to the number and types of the source channels the input data analyzer 11A decides. Accordingly, in addition to the advantages of the foregoing embodiment 1, the present embodiment 3 offers an advantage of being able to save the using areas of the buffer 13, when the number of the source channels of the input data stream is less than the maximum number of the available output channels.

The buffer controller 13A of the present embodiment 3 can be incorporated into the foregoing embodiment 2 as shown in FIG. 3. In this case, in response to the number and types of the source channels the input data analyzer 11A of the audio decoder 11 decides, the buffer controller 13A controls, as in the present embodiment 3, the storage areas the buffer 13 uses for temporarily storing the output data from the audio decoder 11, which are associated with the decoded data the decoding processor outputs.

### Embodiment 4

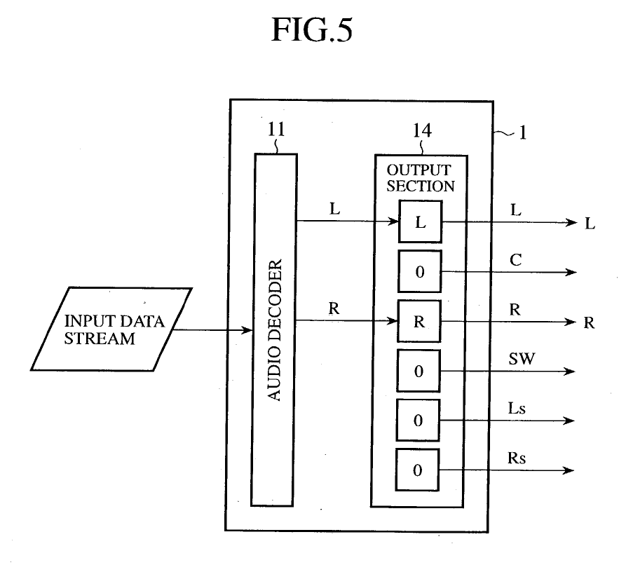

FIG. 5 is a block diagram showing a configuration of an embodiment 4 of the audio decoding reproduction apparatus 1 in accordance with the present invention. In FIG. 5, the same reference numerals and symbols as those of FIG. 1 designate the same or like portions, and their detailed description will be omitted.

The present embodiment 4 differs from the foregoing embodiment 1 of FIG. 1 in that it does not includes the buffer 13, so that the audio decoder 11 supplies its output directly to the output section 14. The audio decoder. 11 is the same as that of the foregoing embodiment 1. In other words, the decoding channel controller 11B adjusts the number and types of the channels of the PCM data to be decoded by the decoding processor 11C in response to the number and types of the source channels the input data analyzer 11A decides (see, FIG. 2). Thus, the number and types of channels of the PCM data to be decoded by the decoding processor 11C (see, FIG. 2) are matched to those of the source channels of the input data stream.

As described above, in addition to the advantages of the foregoing embodiment 1, the present embodiment 4 offers an advantage of being able to reduce not only the number of components, but also the amount of the data transfer because the buffer 13 is not installed.

The foregoing embodiments are applicable not only to the apparatus designed specifically for the audio decoding reproduction, but also to apparatuses designed for the audio and video reproduction. The applicant of the present invention intends that such reproduction apparatuses are also within the scope of the following claims.

What is claimed is:

1. An audio decoding reproduction apparatus including an audio decoder for decoding an input data stream, and an output section for supplying an output of the audio decoder to an external apparatus, said audio decoder comprising:
an input data analyzer for analyzing the input data stream to make a decision as to a number and types of source channels of the input data stream;
a decoding processor for generating decoded data of at least one channel by decoding data contained in the input data stream; and
a decoding channel controller for adjusting, in response to the number and types of the source channels said input data analyzer decides, a number and types of channels of the data to be decoded by said decoding processor.

2. The audio decoding reproduction apparatus according to claim 1, further comprising a buffer for temporarily storing and sequentially outputting the decoded data said decoding processor outputs.

3. The audio decoding reproduction apparatus according to claim 2, further comprising a buffer controller for controlling storage areas used by said buffer in response to the number and types of the source channels said input data analyzer decides.

4. The audio decoding reproduction apparatus according to claim 2, further comprising a down mixer for converting the decoded data said decoding processor outputs to output data with a number of output channels of said output section in accordance with a specified number and types of speakers.
